(19) United States
(12) Patent Application Publication
(10) Pub. No.: US 2010/0213704 A1
(43) Pub. Date: Aug. 26, 2010

(54) Device for Connecting a Fixed Line to an Absorber Pipe of a Solar-Thermal Power Plant

(75) Inventors: Stefan Burger, Baunatal (DE); Francisco Ortiz Vives, Vellmar (DE)

Correspondence Address: THE WEBB LAW FIRM, P.C., 700 KOPPERS BUILDING, 436 SEVENTH AVENUE, PITTSBURGH, PA, 15219, US

(73) Assignee: SENIOR BERGHOFER GMBH, Kassel (DE)

(21) Appl. No.: 12/681,870

(22) PCT Filed: Oct. 7, 2008
(86) PCT No.: PCT/EP08/63395

§ 371 Date: Apr. 6, 2010

(30) Foreign Application Priority Data
Oct. 8, 2007 (DE) 10 2007 048 745.4

(51) Int. Cl. F16L 27/10

(52) U.S. Cl. 285/223

(57) ABSTRACT

The invention relates to a device for connecting a fixed line to an absorber pipe of a solar-thermal power plant, at least one solar collector being able to perform a pivot motion about the absorber pipe, characterized by a) a flexible pipe connection between the fixed line and the absorber pipe and a b) means for connecting the flexible pipeline to the absorber pipe with zero torque and/or zero force. Acceptable mobility of the solar collectors is thus ensured even at high temperatures and/or pressures.

This invention relates to a device for connecting a fixed line to an absorber pipe of a solar-thermal power plant according to the generic part of claim 1.

Today, solar-thermal power plants are increasingly used to generate energy in an environmentally friendly way. Such power plants include solar collectors, such as parabolic mirrors. Especially in parabolic trough power plants, collectors include parabolic trough mirrors and receiver pipes (also referred to as absorber pipes). With these parabolic trough mirrors the solar radiation is collected and via receiver pipes released into a working medium, e.g. oil. In the process, temperatures of 500° C. or more can be reached in the system. Since the solar collectors must be designed to be movable due to the apparent movement of the sun, there are high requirements as to the connections used between parts of the plant.

It is the object underlying the invention to create a device which ensures an excellent movability of the solar collectors even at high temperatures and/or pressures.

In accordance with the invention, this object is solved by a device with the features of claim 1.

A flexible pipe connection is arranged between a fixed line and an absorber pipe, wherein a means is provided for connecting the flexible pipeline to the absorber pipe with zero torque and/or zero force.

Advantageously, the means for torque-free connection includes a flexible pipeline whose first end is connected to the absorber pipe and whose second end is rotatably mounted, wherein the axis of rotation of the second end is alignment with the swivel axis of the at least one solar collector. Due to this geometric arrangement, a torque-free connection is made possible in a simple way.

Furthermore, it is advantageous when the means for torque-free connection includes a means for synchronizing the swivel movement of the flexible pipe connection with the swivel movement of the at least one solar collector.

For obtaining a forced guidance it is advantageous when the swivel movement can be transmitted by a rigid connecting element between a swivel drive of the at least one solar collector and the flexible pipe connection.

A particularly advantageous aspect is obtained when the flexible pipe connection is coupled with a rotary union at one end.

The pressure and temperature requirements advantageously can be satisfied by a flexible pipe connection which includes a metal hose. The metal hose can constitute a multilayer corrugated metal hose.

For absorbing forces it is advantageous when the flexible pipe connection is coupled with a compensator system comprising at least one angular compensator, at least one universal compensator and/or at least one cardanic compensator, in particular three angular compensators. Furthermore, it is advantageous when the flexible pipe connection is coupled with at least one lateral compensator alternatively or in addition.

It is also advantageous when at least one drive is arranged in alignment with the axis of rotation of a rotary union.

The invention will be explained in detail below by means of several embodiments with reference to the Figures of the drawings, in which:

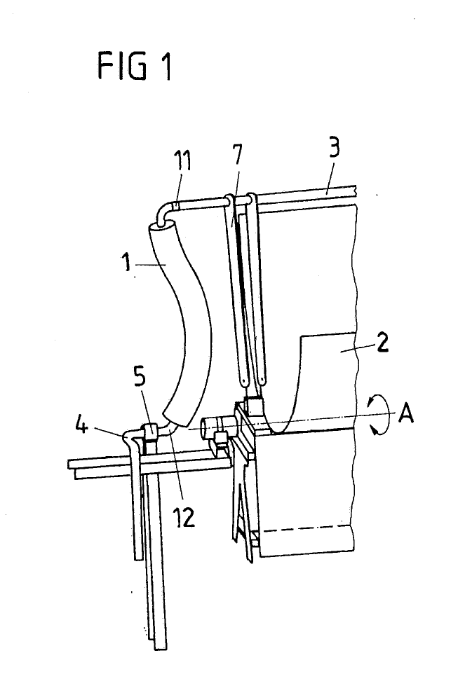

FIG. 1 shows a perspective view of a first embodiment of the device in accordance with the invention;

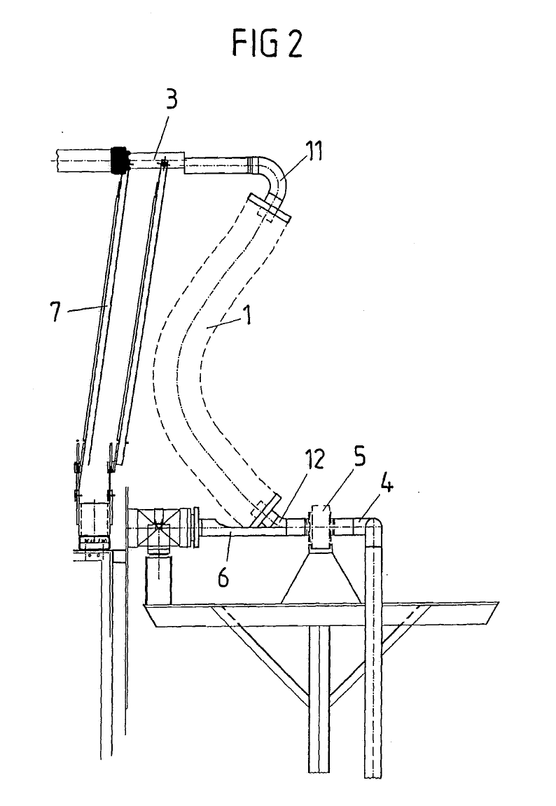

FIG. 2 shows a side view of a second embodiment of the device in accordance with the invention;

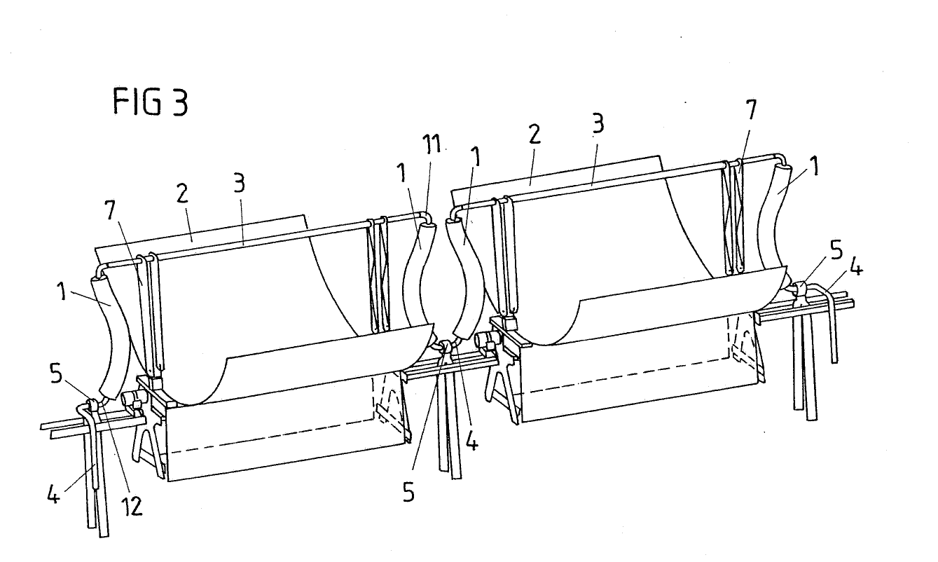

FIG. 3 shows a perspective view of a third embodiment of the device in accordance with the invention;

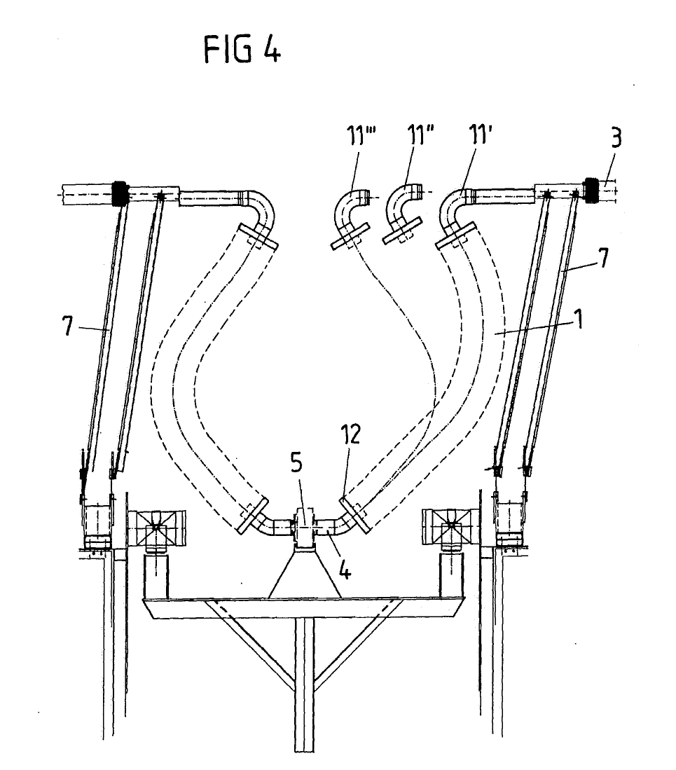

FIG. 4 shows a detailed view of the third embodiment;

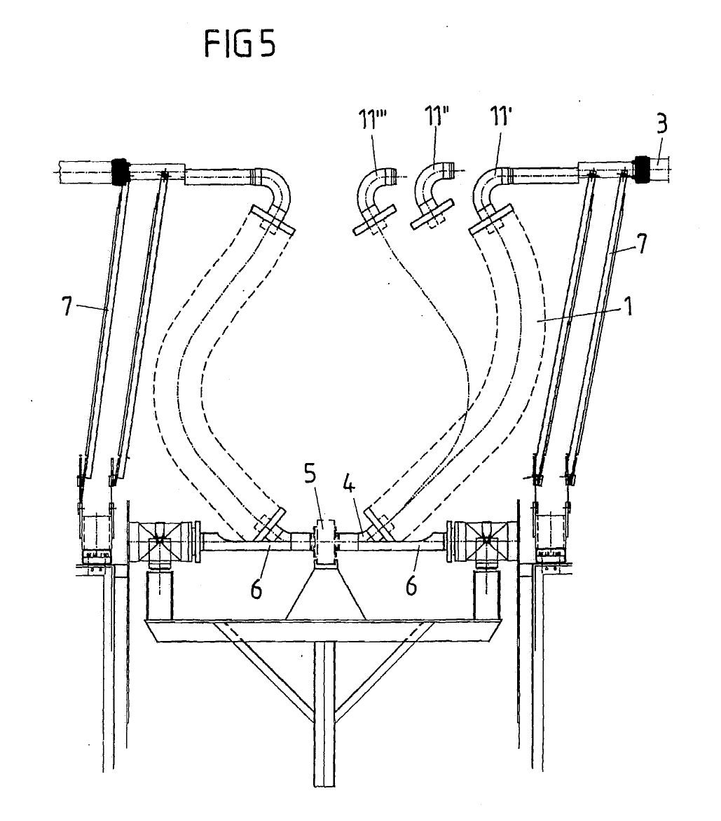

FIG. 5 shows a side view of a fourth embodiment of the device in accordance with the invention.

Due to the apparent sun movement, collectors 2 of solar-thermal power plants must be adjusted to the changing position of the sun in the course of the day.

When e.g. parabolic trough mirrors are used as collectors 2 in a solar-thermal power plant, the focal line is erected in north-south direction and swiveled about an axis of rotation A in east-west direction, following the course of the sun.

The medium (e.g. oil) to be heated by the solar radiation is passed through absorber pipes 3 (also referred to as receiver pipes) which substantially lie in the focal line of the parabolic trough mirrors.

Taking into account a thunderstorm parking position the mirror surface is directed downwards), a swivel movement of the collectors 2 of about 270° around the axis A is obtained.

Solar-thermal power plants operating e.g. according to the parabolic trough mirror principle require flexible elements between a fixed pipeline 4 and the absorber pipes 3 performing the swivel movement. The fixed line 4 is a line for the absorber medium, which is firmly mounted relative to the absorber pipes 3.

Due to the high thermal load, the flexible pipelines 1 and their connections are subjected to great mechanical loads. As operating temperatures 500° C. can be reached, and as pressures up to 100 bar.

Therefore, it must be expected that linear expansions of the components used (e.g. absorber pipe 3, fixed line 4) must also be absorbed transverse to the swivel plane of the solar collectors 2.

In the following, the connection of at least one fixed line with an absorber pipe 3 of a solar plant will be described with reference to various embodiments.

FIG. 1 shows a part of a solar-thermal plant which includes a parabolic solar collector 2. As will be explained below, such solar-thermal plants mostly include a multitude of solar collectors 2.

Sunlight incident on this solar collector 2 is collected and bundled in the focal line. In the focal line an absorber pipe 3 is arranged, which is traversed by an absorber medium, here oil. This absorber medium flows through a flexible pipeline 1, a rotary union 5 and a fixed line 3, so as to release the stored heat in succeeding process steps (not shown here).

A rotary union 5 in particular is understood to be a device which provides for transmitting a mechanical rotary movement through an object such as a container wall. Rotary unions can e.g. of the uniaxially surface-sealing type or of the multiaxially spherically sealing type. In the present embodiment, the flexible pipeline 1 is rotatably arranged in the rotary union 5.

The flexible pipeline 1 here constitutes a multilayer corrugated metal hose (diameter e.g. 50 or 65 mm). To withstand high pressures, the metal hose is provided with a braid. To reduce the heat losses, the flexible pipeline is surrounded with a flexible insulating layer. As outside temperature of the flexible pipeline, 70 to 80° C. can be assumed. The insulating layer then is surrounded by a vapor barrier and a mechanical protection layer made of a wrapped profile hose.

The solar collector 2 is designed to be swiveled about the axis A, with the swivel angle depending on the position of the sun. An emergency-off position with a parabolic mirror pointing towards the ground is also possible.

When the solar collector 2 is swiveled, the absorber pipe 3 moves with the same. A connecting element 7 disposed in direction of rotation connects the swivel axis (A) of the solar collector 2 with the absorber pipe 3. Via the absorber pipe 7, the flexible pipeline 1 is carried along, wherein due to the geometrical arrangement a torque-free and/or force-free drive of the flexible pipeline 1 is not ensured.

Not torque-free and/or force-free in this connection means that the torques and/or forces occurring at the connection mechanically act on the absorber pipe 3 and urge the same out of focus.

The geometrical arrangement includes a first end of the flexible pipeline 1, which is non-rotatably connected with the absorber pipe 3, so that this first end 11 must fold the movement of the absorber pipe 3 and of the solar collector 2. In addition, compensating movements are performed, which are e.g. based on the linear expansion of the absorber pipe 3. Due to the high temperature differences between the ambient air condition and the temperatures of the parts of the plant in the operating condition, an axial linear expansion of the absorber pipe 3 can occur. A linear expansion in the order of 50 cm is quite possible. This linear expansion is also compensated by the flexible pipeline 1 (see FIG. 4 for various positions of the flexible pipeline 1).

The second end 12 of the flexible pipeline 1 is connected with the fixed line 4. The connection is made via the rotary union 5.

When the absorber pipe 3 now is swiveled, the flexible pipeline 1 is also moved due to the connection at the first end 11, without a significant torque acting on the absorber pipe 3. The same applies to operating situations in which the absorber pipe 3 undergoes a linear expansion due to thermal influences.

In addition, the pressure losses in the flexible pipeline 1 are minimized, because the system has no reductions in diameter both in the flexible and in the rotational elements. The diameters of the connected pipes are maintained without loss in the elements.

The forces acting on the connected pipelines are avoided, because the flexible elements underlying the invention compensate the forces themselves to a very large extent and do not exert forces on the connected pipes. This is particularly important for the forces acting on the absorber pipe 3, because unaffected by external influences the same undergoes no deflection. Now, the absorber pipe 3 always remains in the focus of the solar collector 2 and can optimally absorb the energy of the highly concentrated solar rays and transmit the same to the fluid flowing through the same.

It is the objective of the embodiment to minimize or completely avoid the forces and moments exerted on the flexible connecting line 1 via the absorber pipe 3.

Advantageously, along with the introduction of force for the rotation of the solar collector 2 with the absorber pipe 3 a synchronous rotation of the rotary union 5 and a simultaneous swivel movement of the flexible elements is effected at the same time.

Advantageously, three-hinge compensator systems are used for high pressure and temperature loads.

The function of the three-hinge compensator system is analogous to the function of hose lines. The different movements here are divided over three compensators, which otherwise is compensated by one hose line. An advantage of the compensator system is a possible higher pressure load.

FIG. 2 shows a second embodiment. A drive 6 is arranged in one axis in alignment with the rotary union 5. The aligned arrangement ensures that the mechanical loads at the connection to the absorber pipe 3 are as low as possible.

Otherwise, this embodiment is similar to the first embodiment, so that reference can be made to the above description.

Due to the synchronous drive of the swivel movement of the solar collector 2 and the rotary union 5 with connected flexible elements for the thermal expansion transverse to the plane of rotation, the absorber pipe 3 is completely relieved of bending forces. A deflection thereby is excluded and the absorber pipe 3 always will remain in the focal point of the solar collector 2 (not shown in FIG. 2). The efficiency and the energy yield of the solar-thermal plant thereby is substantially increased.

The length of the solar collectors 2 can be increased, so that more favorable manufacturing and operating costs are achieved.

FIG. 3 shows a third embodiment which is similar to the first embodiment. There is shown a larger section of a solar-thermal plant, namely two solar collectors 3. To the left and to the right of the two illustrated solar collectors 3, an arbitrary number of further solar collectors 3 can be arranged in principle.

Like in the first embodiment, the flexible pipelines 1 are connected with the absorber pipes 3 at the first end 11. At the second end 12, they are connected with fixed lines 4 via rotary unions 5.

FIG. 4 shows a detailed view of the pipe connections of the embodiment illustrated in FIG. 3. At the first end 11 of the flexible pipeline 1 shown on the right it is illustrated how the connection to the absorber pipe 3 can be shifted due to thermal expansions. In the cold condition, the first position 11′ is taken, in the heated condition the second position 11″ and in the hot condition the third position 11′″.

In FIG. 5 a fourth embodiment is shown which is similar to the second embodiment (FIG. 2). Two drives 6 are provided here, which are aligned with the axis of rotation of the rotary union 5. Like in FIG. 4, there is also shown the compensation of the linear expansion of the absorber pipe 3.

Due to this configuration, it is possible to put individual absorber segments out of operation without influencing the operation of the remaining segments. This can be of major importance in maintenance or repair cases.

The described embodiments are described in conjunction with parabolic mirrors as solar collectors 3. In principle, embodiments of the invention can also be used in other types of solar-thermal power plants which include an absorber medium that is heated by the solar radiation. Other arrangements of the solar collectors 3 are also possible in principle.

The invention is not limited in its configuration to the preferred embodiments described above. Rather, a number of variants are conceivable, which make use of the device in accordance with the invention also in basically different configurations.

### LIST OF REFERENCE NUMERALS

1 flexible pipeline

2 solar collector

3 absorber pipe

4 fixed line

5 rotary union

6 drive

7 rigid connecting element

11 first end of the flexible pipeline

12 second end of the flexible pipeline

A swivel axis of the solar collector

1-10. (canceled)

11. A device for connecting a fixed line to an absorber pipe of a solar-thermal power plant, wherein a swivel movement of at least one solar collector can be performed around the absorber pipe, comprising:
a) a flexible pipeline between the fixed line and the absorber pipe, and
b) a means for the torque-free and/or force-free connection of the flexible pipeline to the absorber pipe.

12. The device according to claim 11, wherein the means for the torque-free connection includes a flexible pipeline whose first end is connected to the absorber pipe and whose second end is rotatably mounted, and wherein the axis of rotation of the second end is in alignment with the swivel axis of the at least one solar collector.

13. The device according to claim 11, wherein the means for the torque-free connection includes a means for synchronizing the swivel movement of the flexible pipe connection with the swivel movement of the at least one solar collector.

14. The device according to claim 11, wherein the swivel movement can be transmitted by a rigid connecting element between a swivel drive of the at least one solar collector and the flexible pipe connection.

15. The device according to claim 11, wherein at one end the flexible pipe connection is coupled with a rotary union.

16. The device according to claim 11, wherein the flexible pipe connection includes a metal hose.

17. The device according to claim 16, wherein the metal hose constitutes a multilayer corrugated metal hose.

18. The device according to claim 11, wherein the flexible pipe connection is coupled with a compensator system comprising at least one angular compensator, at least one universal compensator and/or at least one cardanic compensator, in particular three angular compensators.

19. The device according to claim 11, wherein the flexible pipe connection is coupled with at least one lateral compensator.

20. The device according to claim 11, further including at least one drive arranged in alignment with the axis of rotation of a rotary union.
